(19) United States
(12) Patent Application Publication
(10) Pub. No.: US 2026/0143098 A1
(43) Pub. Date: May 21, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Jaedong KIM, Suwon-si (KR); Changmin KEUM, Suwon-si (KR); Hyungjoo SEO, Suwon-si (KR)

(73) Assignee: SAMSUNG ELECTRONICS CO., LTD., Suwon-si (KR)

(21) Appl. No.: 19/350,870

(22) Filed: Oct. 6, 2025

Related U.S. Application Data
(63) Continuation of application No. PCT/KR2025/013310, filed on Aug. 29, 2025.

(30) Foreign Application Priority Data
Nov. 18, 2024 (KR) 10-2024-0164021

(51) Int. Cl. H04N 9/31

(52) U.S. Cl. CPC H04N 9/3194; H04N 9/3185

(57) ABSTRACT

An electronic apparatus, including: a camera; at least one processor; and a memory storing instructions which, when executed individually or collectively by the at least one processor, cause the electronic apparatus to: obtain a first internal parameter associated with a lens of a projector configured to project an image, and a second internal parameter associated with the camera, capture, using the camera, a pattern image projected onto a projection surface by the projector, determine pose information about a pose of the electronic apparatus and projection surface information about the projection surface based on the first internal parameter, the second internal parameter, and the captured pattern image, obtain virtual viewpoint information about a virtual viewpoint positioned at a front side of the projection surface based on the projection surface information, and generate keystone correction information based on the virtual viewpoint information, wherein the keystone correction information is used to perform keystone correction on at least one image projected onto the projection surface by the projector.

### CROSS-REFERENCE TO RELATED APPLICATION

This application is a continuation application of International Application No. PCT/KR2025/013310 designating the United States, filed on Aug. 29, 2025, in the Korean Intellectual Property Receiving Office and claiming priority to Korean Patent Application No. 10-2024-0164021 filed on Nov. 18, 2024 in the Korean Intellectual Property Office, the disclosure of which is incorporated by reference herein in its entirety.

### BACKGROUND

### (1) Field

The present disclosure relates to an electronic apparatus and a controlling method thereof, and more particularly to an electronic apparatus capable of performing keystone correction on an image projected by an external projector and a controlling method thereof.

### (2) Description of the Related Art

A projector may refer to an electronic apparatus that projects light to, toward, or onto a projection surface (e.g., a screen), and causes an image to be formed on the projection surface. In addition, mobile electronic apparatuses (e.g., a robot, etc.) may include such a projector. The mobile electronic apparatus may provide a user with various information using the projector while moving in a specific space (e.g., within a home, a restaurant, an airport, etc.)

When using a mobile projector, keystone correction may help to project an image on a projection surface from various angles. According to some approaches, the projector may perform the keystone correction directly, but this may cause problems such as requiring various sensors for performing the keystone correction, and requiring a relatively large amount of computing resources due to increasing computational complexities.

Accordingly, there is a need for a method by which keystone correction of an image projected by the projector may be performed using another electronic apparatus.

### SUMMARY

In accordance with an aspect of the disclosure, an electronic apparatus includes: a camera; at least one processor; and a memory storing instructions which, when executed individually or collectively by the at least one processor, cause the electronic apparatus to: obtain a first internal parameter associated with a lens of a projector configured to project an image, and a second internal parameter associated with the camera, capture, using the camera, a pattern image projected onto a projection surface by the projector, determine pose information about a pose of the electronic apparatus and projection surface information about the projection surface based on the first internal parameter, the second internal parameter, and the captured pattern image, obtain virtual viewpoint information about a virtual viewpoint positioned at a front side of the projection surface based on the projection surface information, and generate keystone correction information based on the virtual viewpoint information, wherein the keystone correction information is used to perform keystone correction on at least one image projected onto the projection surface by the projector.

The instructions, when executed individually or collectively by the at least one processor, may further cause the electronic apparatus to: determine, using a fundamental matrix, a center pixel positioned between a plurality of patterns included in the pattern image and pattern pixels corresponding to the plurality of patterns, and determine, using the fundamental matrix, pixel matching information between the pattern pixels and the center pixel.

The pose information and the projection surface information may be determined such that the pattern pixels are positioned on one plane based on the pixel matching information.

The virtual viewpoint may be spaced apart from the projection surface by a predetermined distance in a forward direction with respect to the projection surface.

The virtual viewpoint may be spaced apart from the center pixel by the predetermined distance.

The instructions, when executed individually or collectively by the at least one processor, may further cause the electronic apparatus to: determine projection area information about a projection area of the pattern image that is visible from the virtual viewpoint based on the pose information and the projection surface information, determine a target projection area having a rectangular shape within the projection area, and determine the keystone correction information based the projection area information and the target projection area.

A size, a projection ratio, and a projection direction of the target projection area may be set according to a user input received using a user interface (UI).

The instructions, when executed individually or collectively by the at least one processor, may further cause the electronic apparatus to: capture the pattern image from a plurality of camera positions using the camera to obtain a plurality of captured pattern images, and obtain the second internal parameter using triangulation by comparing a plurality of positions of a specific point within the plurality of captured pattern images and the plurality of camera positions of the camera.

The first internal parameter may include information about a focal length of the lens and a principal point of the lens, and the second internal parameter may include information about a focal length of the camera and a principal point of the camera.

In accordance with an aspect of the disclosure, a controlling method of an electronic apparatus includes: obtaining a first internal parameter associated with a lens of a projector configured to project an image, and a second internal parameter associated with a camera of the electronic apparatus; capturing, using the camera, a pattern image projected onto a projection surface by the projector; determining pose information about a pose of the electronic apparatus and projection surface information about the projection surface based on the first internal parameter, the second internal parameter, and the captured pattern image; obtaining virtual viewpoint information about a virtual viewpoint positioned at a front side of the projection surface based on the projection surface information; and generating information about keystone correction based on the virtual viewpoint information, wherein the keystone correction information is used to perform keystone correction on at least one image projected onto the projection surface by the projector.

The determining of the pose information and the projection surface information may include: determining, using a fundamental matrix, a center pixel positioned between a plurality of patterns included in the pattern image and pattern pixels corresponding to the plurality of patterns, and determining, using the fundamental matrix, pixel matching information between the pattern pixels and the center pixel captured by the camera.

The determining of the pose information of the electronic apparatus and the projection surface information may include: wherein the pose information and the projection surface information are determined such that the pattern pixels are positioned on one plane based on the pixel matching information.

The virtual viewpoint may be spaced apart from the projection surface by a predetermined distance in a forward direction with respect to the projection surface.

The virtual viewpoint may be spaced apart from the center pixel by the predetermined distance.

The determining of the keystone correction information may include: determining projection area information about a projection area of the pattern image that is visible from the virtual viewpoint based on the pose information and the projection surface information; determining a target projection area having a rectangular shape within the projection area; and determining the keystone correction information based on the projection area information and the target projection area.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an image projection system including an electronic apparatus and a projector according to an embodiment of the disclosure;

FIG. 2 is a block diagram illustrating an example of an electronic apparatus according to an embodiment of the disclosure;

FIG. 3 is a block diagram illustrating an example of a projector according to an embodiment of the disclosure;

FIG. 4 is a sequence diagram illustrating an example in which an electronic apparatus obtains keystone correction information using a pattern image projected by a projector according to an embodiment of the disclosure;

FIG. 5 is a diagram illustrating a pattern image projected by a projector according to an embodiment of the disclosure;

FIG. 6 is a diagram illustrating a pattern image captured by an electronic apparatus according to an embodiment of the disclosure;

FIG. 7A to FIG. 7C are diagrams illustrating an embodiment for obtaining pixel matching information based on various poses of the electronic apparatus according to an embodiment of the disclosure;

FIG. 8 is a diagram illustrating a virtual viewpoint according to an embodiment of the disclosure;

FIG. 9 is a diagram illustrating a projection area and a target projection area according to an embodiment of the disclosure;

FIG. 10A to FIG. 10D are diagrams illustrating an embodiment for setting various target projection areas according to a user input according to various embodiments of the disclosure;

FIG. 11A and FIG. 11B are diagrams illustrating an effect of an image projected through keystone correction according to an embodiment of the disclosure;

FIG. 12 is a diagram illustrating an embodiment for objecting an internal parameter of an electronic apparatus by capturing a pattern image from a plurality of areas according to an embodiment of the disclosure;

FIG. 13 is a flowchart illustrating an example in which an electronic apparatus projects an image by performing keystone projection according to an embodiment of the disclosure; and

FIG. 14 is a sequence diagram illustrating an example in which an electronic apparatus transmit a keystone corrected image to a projector by performing keystone correction according to an embodiment of the disclosure.

### DETAILED DESCRIPTION

Various modifications may be made to the embodiments of the disclosure, and there may be various types of embodiments. Accordingly, specific embodiments are illustrated in the drawings, and these specific embodiments are described in detail in the detailed description. However, it should be noted that the scope of the disclosure is not intended to be limited to these specific embodiments, and instead should be interpreted to include all modifications, equivalents or alternatives of the embodiments included in the ideas and the technical scopes disclosed herein. With respect to the description of the drawings, like reference numerals may be used to indicate like elements.

To avoid obscuring the disclosure, unnecessarily detailed description some elements may be omitted.

Further, the embodiments described below may be modified to various different forms, and it is to be understood that the scope of the technical spirit of the disclosure is not limited to the particular embodiments described below. Rather, the embodiments are provided so that the disclosure is thorough and complete, and to fully convey the technical spirit of the disclosure to those skilled in the art.

Terms used in the disclosure are merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and B”, “one or more of A and B”, “at least one of A or B”, “one or more of A or B” “at least one of A and/or B”, “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

Conversely, when the certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ”, “having the capacity to . . . ”, “designed to . . . ”, “adapted to . . . ”, “made to . . . ”, or “capable of . . . ” based on circumstance. The term “configured to . . . (or set up to)” may not necessarily mean “specifically designed to” in terms of hardware.

Rather, in a certain circumstance, the expression “a device configured to . . . ” may mean that the device “may perform . . . ” together with another device or components. For example, a phrase “a processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term “module” or “part” used in one or more embodiments herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

The various elements and areas of the drawings have been schematically illustrated. Accordingly, the technical spirit of the disclosure is not limited by relative sizes and distances illustrated in the accompanied drawings.

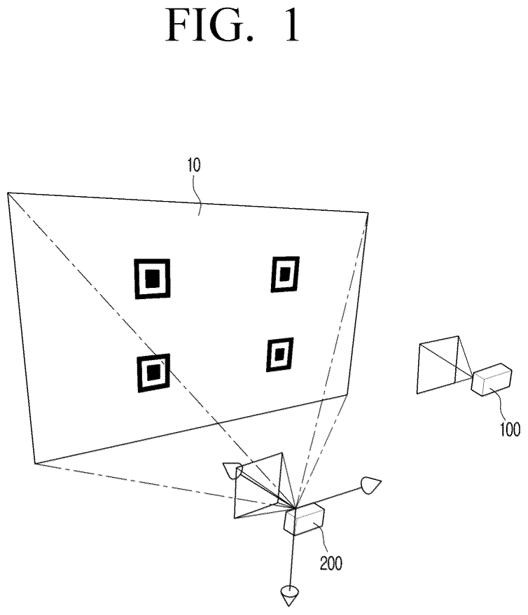

FIG. 1 is a diagram illustrating an image projection system including an electronic apparatus and a projector according to an embodiment of the disclosure. As shown in FIG. 1, the image projection system may include an electronic apparatus 100 and a projector 200. For example, the electronic apparatus 100 may be implemented as a smartphone, but embodiments are not limited thereto, and the electronic apparatus 100 may be implemented as various terminal devices capable of capturing a projection surface 10 such as, for example, and without limitation, a tablet personal computer (PC), a wearable device, and the like. The projector 200 may be a device configured to project an image onto the projection surface 10, and may be a mobile projector, but embodiments are not limited thereto, and the projector may be implemented in various apparatuses such as a robot.

The projector 200 may project an image toward the projection surface 10. For example, the projector 200 may be a mobile device, and a phenomenon of the image being distorted may occur when the projector 200 is moved, when the image is projected toward the projection surface 10 from a moved position, and if the moved position is not a front side direction (e.g., a forward direction) of the projection surface 10. According to embodiments, the front side direction of the projection surface 10 may mean a direction toward a front side of the projection surface 10, and may be referred to as a forward direction with respect to the projection surface 10. To solve this phenomenon, the projector 200 may allow a user to view a rectangular image using keystone correction. According to embodiments, keystone correction may refer to a process for correcting a distortion caused when the projection surface is not properly aligned with the projector (e.g., not entirely perpendicular to the projector). For example, when the image is projected onto a particular projection surface that is not properly aligned with the projector, the distortion may cause a distorted image when viewed from a particular viewpoint. Accordingly, keystone correction may be performed by adjusting a shape of the projected image such that the distorted image appears to have a rectangular shape (or other desired shape) when viewed from the particular viewpoint.

According to embodiments, to perform keystone correction, the projector 200 may obtain information about keystone correction (which may be referred to as keystone correction information) by operating in association with (e.g., together with) the electronic apparatus 100.

For example, the projector 200 may project a pattern image toward the projection surface 10. For example, the pattern image may be an image including at least one pattern at a predetermined position as shown in FIG. 1.

The electronic apparatus 100 may capture the pattern image projected toward the projection surface 10 from a random or arbitrary position. Then, the electronic apparatus 100 may obtain pose information of the electronic apparatus 100 and information about the projection surface 10 (which may be referred to as projection surface information) using a first internal parameter and a second internal parameter and the captured pattern image. For example, an internal parameter may be a parameter for a focal length or a principal point of a lens. In addition, the pose information of the electronic apparatus 100 may include information about a position and pose (or direction) of the electronic apparatus 100 within a 3-dimensional space. For example, the pose information may mean information about a 6-axis direction. The electronic apparatus 100 may obtain coordinate information for the 3-dimensional space in which the image projection system is positioned based on pose information of the electronic apparatus 100 and information about the projection surface 10.

The electronic apparatus 100 may identify or determine a virtual viewpoint which is spaced apart by a predetermined distance from the projection surface 10 in the forward direction, and obtain keystone correction information which shows an image projected from the virtual viewpoint in a rectangular shape.

The electronic apparatus 100 may transmit the obtained keystone correction information toward the projector 200, and the projector 200 may correct the projected image using the keystone correction information.

Examples of a method by which the electronic apparatus 100 may obtain the keystone correction information are described in greater detail below.

As described above, based on the electronic apparatus 100 obtaining keystone correction information by analyzing the pattern image projected by the projector 200, the projector 200 may perform keystone correction in association with the electronic apparatus 100 without using separate sensors.

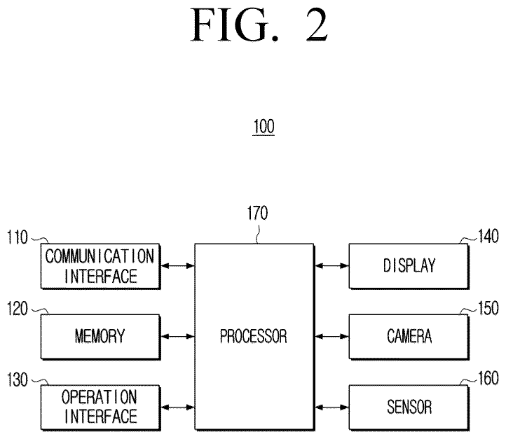

FIG. 2 is a block diagram illustrating an example of an electronic apparatus according to an embodiment of the disclosure. As shown in FIG. 2, the electronic apparatus 100 may include a communication interface 110, a memory 120, an operation interface 130, a display 140, a camera 150, a sensor 160, and a processor 170. However, the configurations shown in FIG. 2 are merely examples, and a portion of the configurations may be omitted, or new configurations may be added.

The communication interface 110 may perform communication with various external devices. For example, the communication interface 110 may receive information about a first internal parameter of the projector 200 or identification information of the projector 200 from the projector 200. Then, the communication interface 110 may transmit at least one of keystone correction information and a keystone corrected image (e.g., an image on which the keystone correction has been performed) to the projector 200.

For example, the communication interface 110 may perform communication with various external devices using various wireless communication technology or mobile communication technology. The wireless communication technology described above may include, for example, Bluetooth, Bluetooth Low Energy, CAN communication, Wi-Fi, Wi-Fi Direct, ultra-wide band (UWB) communication, ZigBee, infrared communication (Infrared Data Association (IrDA)), Near Field Communication (NFC), or the like, and the mobile communication technology may include 3rd Generation Partnership Project (3GPP), Wi-Max, Long Term Evolution (LTE), 5th Generation (5G), and the like.

The memory 120 may store instructions or data associated with an operating system (OS) and elements of the electronic apparatus 100 to control the overall operation of the elements of the electronic apparatus 100. For example, the memory 120 may include various modules for obtaining keystone correction information. For example, when an event for obtaining keystone correction information occurs, the electronic apparatus 100 may have various modules stored in a non-volatile memory perform loading of data for performing various operations in a volatile memory. For example, the loading may mean an operation of calling data stored in the non-volatile memory to the volatile memory for the processor 170 to access, and storing the same.

According to embodiments, the memory 120 may be implemented as the non-volatile memory (e.g., a hard disk, a solid state drive (SSD), a flash memory), the volatile memory (may include a memory in the processor 170), and the like.

For example, the memory 120 may store information about a second internal parameter of the electronic apparatus 100. In addition, the memory 120 may store information about the first internal parameter of the projector 200 received from outside (e.g., from an outside of the electronic apparatus 100).

The operation interface 130 may include a button, a lever, a switch, a touch-type interface, a microprocessor, and the like. For example, the touch-type interface may be implemented in a method of receiving input by touch of a user on a screen of the display 140 of the electronic apparatus 100. For example, the operation interface 130 may receive a user input for obtaining keystone correction information.

The display 140 may provide various information. For example, the display 140 may provide a user interface (UI) for setting a target projection area. In addition, the display 140 may provide information about the captured pattern image.

The camera 150 may be configured to generate a captured image by capturing a subject, and the captured image herein may include both a moving image and a still image. According to embodiments, the term “image” include both an image output on the display 140 and an image frame captured by the camera 150. For example, the camera 150 may capture the pattern image projected by the projector 200.

The sensor 160 may generate an electric signal or data value corresponding to an internal operating state, or an external environmental state of the electronic apparatus 100. The sensor 160 may include at least one from among, for example, a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor. For example, the sensor 160 may store information about a movement and a pose of the electronic apparatus 100 using the acceleration sensor, the gyro sensor, and the like.

The processor 170 may control the electronic apparatus 100 according to at least one instruction stored in the memory 120.

For example, the processor 170 may include one or more processors. In particular, the one or more processors may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors may control one or a random combination from among other elements of the electronic apparatus, and perform an operation associated with communication or data processing. The one or more processors may execute one or more programs or instructions stored in the memory. For example, the one or more processors may perform, by executing one or more instructions stored in the memory, a method according to an embodiment of the disclosure.

When a method according to an embodiment of the disclosure includes a plurality of operations, the plurality of operations may be performed by one processor, or performed by a plurality of processors. That is, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor). As an example, according to an embodiment of the disclosure, an operation for identifying or determining a corner within a hand writing image using a neural network model, or for correcting a space within the hand writing image, and the like may be performed by a processor which performs parallel operations such as GPU or NPU, and operations for generating/editing plan view images or post-processing operations and the like may be performed by a generic-purpose processor such as the CPU.

The one or more processors may be implemented as a single core processor that includes one core, or implemented as one or more multicore processors that include a plurality of cores (e.g., a homogeneous multicore or a heterogeneous multicore). If the one or more processors are implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the processor 170 may refer to a system on chip (SoC), a single core processor, or multicore processors in which the one or more processors and other electronic components are integrated or a core included in the single core processor or the multicore processors, and the core herein may be implemented as the CPU, the GPU, the APU, the MIC, the DSP, the NPU, the hardware accelerator, the machine learning accelerator, or the like, but the embodiments of the disclosure are not limited thereto.

For example, the processor 170 may obtain, by executing the at least one instruction stored in the memory 120, the first internal parameter associated with a lens of the projector 200 that projects an image and the second internal parameter associated with a camera of the electronic apparatus 100, capture a pattern image projected onto a projection surface by the projector 200 through the camera 150, identify or determine pose information of the electronic apparatus 100 and projection surface information based on the first internal parameter, the second internal parameter, and the captured pattern image, obtain information about a virtual viewpoint positioned at a front side of the projection surface based on the projection surface information, and obtain keystone correction information based on the information about the virtual viewpoint. According to embodiments, the information about the virtual viewpoint may be referred to as virtual viewpoint information.

In one or more embodiments, the processor 170 may identify or determine, using a fundamental matrix, a center pixel positioned between pattern pixels corresponding to a plurality of patterns and the plurality of patterns included in the pattern image projected by the projector, and pixel matching information between the pattern pixels and the center pixel captured by the camera. For example, the fundamental matrix may refer to a matrix that relates corresponding points in a pair of images, but embodiments are not limited thereto. In some embodiments, the fundamental matrix may be a 3×3 matrix that encodes the intrinsic projective geometry between two views (e.g., images of the same scene captured from different camera positions) and maps a point in one image to a corresponding epipolar line in the other image.

In one or more embodiments, the processor 170 may identify or determine the pose information of the electronic apparatus and the projection surface information about a projection surface on which the pattern pixels are positioned on one plane based on the pixel matching information. For example, the processor 170 may determine or select pose information and projection surface information which causes or allows the pattern pixels to be positioned on one plane on the projection surface. This may mean, for example, that the processor 170 may find, identify, select, or determine a plane on which the pattern pixels are positioned (e.g., a place which includes all of the pattern pixels), and may select pose information and the projection surface information based on this plane (e.g., such that the projection surface includes or is collocated with the plane).

In one or more embodiments, the processor 170 may identify or determine, as the virtual viewpoint, a viewpoint spaced apart by a predetermined distance from the projection surface on which the pattern pixels are positioned on one plane in the forward direction. For example, the virtual viewpoint may be a viewpoint spaced apart from the center pixel by the predetermined distance.

In one or more embodiments, the processor 170 may identify or determine information about a projection area of a pattern image projected by the projector 200 that is visible from the virtual viewpoint based on the pose information of the electronic apparatus 100 and the projection surface information, identify or determine a target projection area of a rectangular shape within the projection area, and obtain keystone correction information based on information about the projection area and the target projection area. According to embodiments, the information about the projection area may be referred as projection area information. For example, the target projection area may be set with a size, a projection ratio, and a projection direction according to a user input through a UI (e.g., a UI provided by the display 140).

In one or more embodiments, the processor 170 may capture the pattern image a plurality of times from a plurality of camera positions using the camera 150 to obtain a plurality of captured pattern images, and may obtain the second internal parameter using triangulation by comparing a position of a specific point within the plurality of captured pattern images and the plurality of camera positions of the camera 150.

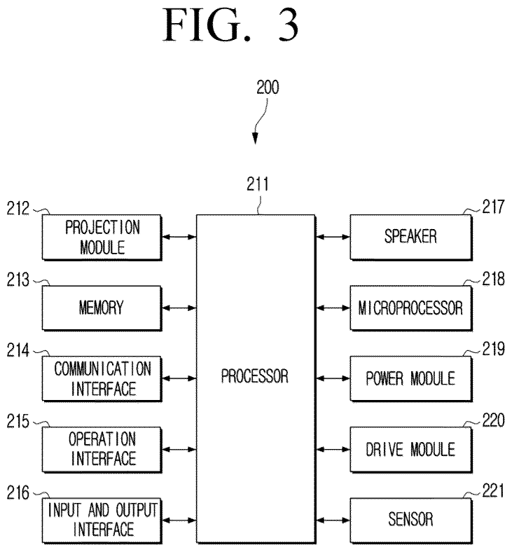

FIG. 3 is a block diagram illustrating an example of a projector according to an embodiment of the disclosure. As shown in FIG. 3, the projector 200 may include at least one from among a processor 211, a projection module 212, a memory 213, a communication interface 214, an operation interface 215, an input and output interface 216, a speaker 217, a microprocessor 218, a power module 219, a drive module 220, or a sensor 221. However, the configurations shown in FIG. 3 are merely examples, and a portion of the configurations may be omitted or new configurations may be added.

The projection module 212 may be configured to externally project an image. According to various embodiments of the disclosure, the projection module 212 may be implemented using various projection methods (e.g., a cathode-ray tube (CRT) method, a liquid crystal display (LCD) method, a digital light processor (DLP) method, a laser method, etc.).

According to embodiments, the projection module 212 may perform various functions for adjusting an output image by control of the processor 211. For example, the projection module 212 may perform functions such as zoom, keystone correction, quick-corner keystone correction (e.g., 4-corner keystone correction), lens shift, and the like.

For example, the projection module 212 may perform a keystone correction function. If a height of front projection is not correct, the screen may be distorted at the top or the bottom. The keystone correction function may refer to a function for correcting a distortion in a projected image (e.g., an image projected onto a screen or other projection surface). As another example, if distortion occurs in a left and right direction of the projected image, correction may be made using a horizontal keystone, and if distortion occurs in a top and bottom direction, correction may be made using a vertical keystone. A quick-corner keystone correction function (e.g., 4-corner keystone correction function) may be a function for correcting the projected image when a center area of the image is correct but balance at corner areas are not correct. A lens shift function may be a function which moves the projected image in its entirety if the screen outside of the screen.

According to embodiments, the projection module 212 may include a first projection lens corresponding to a first focus distance and a second focus projection lens corresponding to a second focus distance. For example, the first projection lens may be a long focus projection lens, and the second projection lens may be an ultra-short projection lens, but embodiments are not limited thereto. The long-focus projection lens may be a lens capable of projecting to a large screen from a long distance, and may project an image from positions that are several meters to tens of meters apart. The ultra-short focus projection lens may be a lens capable of projecting to a large screen from a very short distance, and may project an image from positions that are several centimeters apart. In addition, the projection module 212 may further include a switching module configured to switch (or change or tilt) the long-focus projection lens and the ultra-short focus projection lens. For example, the projector 212 may switch between the long-focus projection lens and the ultra-short focus projection lens using the switching module by control of the processor 211.

The memory 213 may be implemented as an internal memory such as a read only memory (ROM) (e.g., an electrically erasable programmable read-only memory (EEPROM)) or a random access memory (RAM) included in the processor 211, or implemented as a memory separate from the processor 211. In this case, the memory 213 may be implemented in a form of a memory embedded in the projector 200 according to data storage use, or implemented in a form of a memory attachable to or detachable from the projector 200. For example, data for driving of the projector 200 may be stored in the memory embedded in the projector 200, and data for an expansion function of the projector 200 may be stored in the memory attachable to or detachable from the projector 200.

The memory 213 may store or be configured to store at least one instruction associated with the projector 200. Further, the memory 213 may store or be configured to store an operating system (O/S) for driving the projector 200. In addition, the memory 213 may store or be configured to store various software programs or applications for the projector 200 to operate according to various embodiments of the disclosure.

The memory 213 may store information about the first internal parameter of the projector 200.

The communication interface 214 may be configured to perform communication with external devices of various types according to communication methods of various types. The communication interface 214 may include at least one of a wireless communication module and a wired communication module. For example, each communication module may be implemented in at least one hardware chip form.

For example, the communication interface 214 may perform communication with an external device. The communication interface 214 may transmit information about the first internal parameter to the electronic apparatus 100, and may receive at least one of keystone correction information from the electronic apparatus 100 and a keystone corrected image (e.g., an image on which the keystone correction has been performed).

The operation interface 215 may include input devices of various types. For example, the operation interface 215 may include a physical button. For example, the physical button may include a function key, a direction key (e.g., a 4-direction key), or a dial button. According to various embodiments, the physical button may be implemented as a plurality of keys. According to another embodiment, the physical button may be implemented as one key. For example, if the physical button is implemented as one key, the projector 200 may receive a user input in which the one key being pressed for an amount of time that is greater than a threshold amount of time, or being pressed a number of times that is greater than a threshold number of times within a predetermined threshold time. If such a user input is received, the processor 211 may perform a function corresponding to the user input.

The input and output interface 216 may be configured to input and output at least one from among an audio signal and an image signal. The input and output interface 216 may receive input of at least one from among the audio signal and the image signal from an external device, and output a control command to the external device.

According to embodiments, the input and output interface 216 according to various embodiments of the disclosure may be implemented as at least one or more wired input and output interfaces from among a High Definition Multimedia Interface (HDMI), a Mobile High-Definition Link (MHL), a Universal Serial Bus (USB), a USB C-type, a Display Port (DP), a Thunderbolt, a Video Graphics Array (VGA) port, an RGB port, a Dsubminiature (D-SUB), and a Digital Visual Interface (DVI). According to various embodiments, the wired input and output interface may be implemented as an interface that inputs and outputs only audio signals and an interface that inputs and outputs only image signals, or implemented as one interface that inputs and outputs both the audio signals and the image signals.

The speaker 217 may be configured to outputting audio signals. For example, the speaker 217 may include an audio output mixer, an audio signal processor, and a sound output module. The audio output mixer may synthesize a plurality of audio signals to be output to at least one audio signal. For example, the audio output mixer may synthesize an analog audio signal and other analog audio signals (e.g., analog audio signals received from outside) to at least one analog audio signal. The sound output module may include a speaker or an output terminal. According to various embodiments, the sound output module may include a plurality of speakers, and in this case, the sound output module may be disposed inside a main body, and the main body may cover at least a portion of a diaphragm of the sound output module and the radiated sound may pass a waveguide and be transferred to outside of the main body. The sound output module may include a plurality of sound output units, based on the plurality of sound output units being disposed symmetrically at an exterior of the main body, sound may be radiated to all directions, that is, 360 degrees in all directions.

The microprocessor 218 may be configured to receive an input of a user voice or other sounds and converting to audio data. The microprocessor 218 may receive the user voice in an activated state. For example, the microprocessor 218 may be integrally formed at an upper side or the forward direction, a side direction, or the like of the processor 200. The microprocessor 218 may include various configurations such as, for example, and without limitation, a microprocessor that collects the user voice in an analog form, an amplifier circuit that amplifies the collected user voice, an A/D converter circuit that samples the amplified user voice and converts to a digital signal, a filter circuit that removes noise components from the converted digital signal, and the like.

The power module 219 may receive power externally and supply power to various elements or components included in the projector 200. The power module 219 according to various embodiments of the disclosure may receive supply of power through various methods.

The drive module 220 may drive at least one hardware element or component included in the projector 200. The drive module 220 may generate physical force and transfer the physical force to the at least one hardware element or component included in the projector 200. For example, the drive module 220 may generate drive power by a movement (e.g., movement of the projector 200) operation of the hardware configuration included in the projector 200.

For example, the drive module 220 may move a position of the projector 200. For example, the drive module 220 may control a movement member to move the projector 200. For example, the drive module 220 may control the movement member using a motor and a wheel. According to embodiments, according to the disclosure, the drive module 220 may be referred to using various terms such as, a traveling part, an operating part, a moving part, and the like.

The sensor 221 may include at least one sensor. For example, the sensor 221 may include at least one from among a tilt sensor that senses tilting of the projector 200, and an image sensor that captures an image. For example, the tilt sensor may mean the acceleration sensor or the gyro sensor, and the image sensor may mean the camera or a depth camera. According to embodiments, the tilt sensor may be described as a movement sensor. In addition, the sensor 221 may include various sensors in addition to the tilt sensor or the image sensor. For example, the sensor 221 may include the illuminance sensor and a distance sensor. The distance sensor may be a Time of Flight (ToF). In addition, the sensor 221 may include a Light Detection and Ranging (LiDAR) sensor.

The processor 211 may be implemented as a digital signal processor (DSP) that processes digital signals, a microprocessor, or a time controller (TCON). However, the embodiment is not limited thereto, and may include one or more from among a central processing unit (CPU), a micro controller unit (MCU), a micro processing unit (MPU), a controller, an application processor (AP), a graphics processing unit (GPU) or a communication processor (CP), and an advanced reduced instruction set computer (RISC) machines (ARM) processor, or may be defined by a relevant term. In addition, the processor 211 may be implemented as a System on Chip (SoC) or a large scale integration (LSI) in which a processing algorithm is embedded, and may be implemented in a form of a field programmable gate array (FPGA). In addition, the processor 211 may perform various functions by executing computer executable instructions stored in the memory 213.

For example, the processor 211 may perform keystone correction on an image based on keystone correction information received from an external electronic apparatus 100. Then, the processor 211 may control the projection module 212 to project the keystone corrected image toward the projection surface.

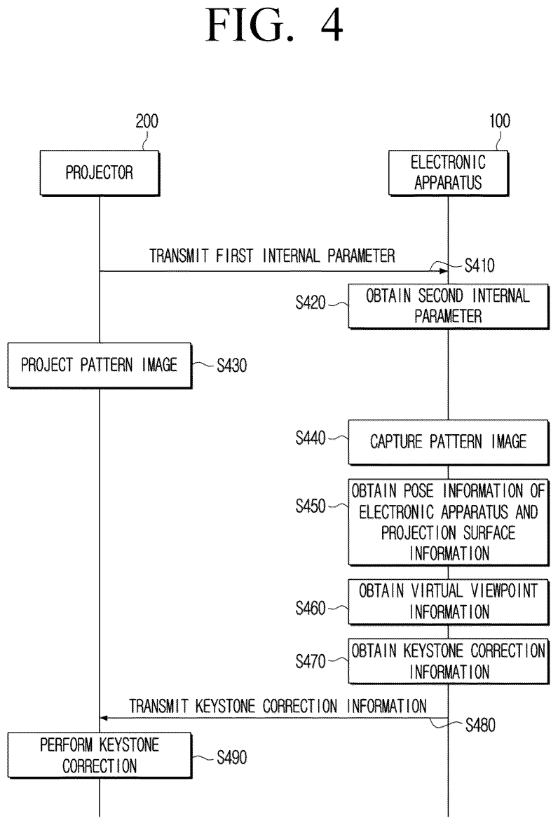

FIG. 4 is a sequence diagram illustrating an example in which an electronic apparatus obtains keystone correction information using a pattern image projected by a projector according to an embodiment of the disclosure. The projector 200 of the disclosure may be a mobile-type projector, but is not limited thereto, and may be implemented as various projector devices such as, for example, and without limitation, a fixed-type projector, a robot, and the like.

Each of the operations described below may be performed sequentially, but embodiments are not limited thereto and in some embodiments the operations may not be performed in sequential order. For example, the order of each of the operations may be changed, or at least two operations may be performed in parallel.

According to one or more embodiments, S410 to S490 may be understood as being performed in a processor (e.g., processor 170 in FIG. 2) of an electronic apparatus (e.g., electronic apparatus 100 in FIG. 2) and a processor (e.g., processor 211 in FIG. 3) of a projector (e.g., projector 200 in FIG. 3).

First, the projector 200 may transmit information about the first internal parameter to the electronic apparatus 100 at operation S410. For example, the first internal parameter may include information about the focal length and the principal point of the lens for the projector 200 to project an image. The focal length may be a distance from a center of a projector lens to a focal point of a projected image (e.g., a point at which an image is clearly formed). The principal point may mean a point at which an optical-axis of the projector lens and the projection surface meet, and a position of the image may be determined from horizontal and vertical directions based on the image projected through the principal point. In one or more embodiments, the processor 200 may obtain information about the first internal parameter from among pre-stored specification information about the projector 200 and then, transmit the information about the first internal parameter to the electronic apparatus 100. However, embodiments are not limited thereto, and the processor 200 may transmit identification information (e.g., a product name, a product number, etc.) on the projector 200 to the electronic apparatus 100, and the electronic apparatus 100 may obtain information about the first internal parameter of the projector 200 from an external server based on the identification information of the projector 200.

The electronic apparatus 100 may obtain the second internal parameter at operation S420. The focal length may be a distance from an optical center of a camera lens to the image sensor (or film). The principal point may be a point at which an optical-axis of the camera meets the image sensor, and may mean a center of the image. In one or more embodiments, the electronic apparatus 100 may obtain information about the second internal parameter from among pre-stored specification information about the electronic apparatus 100. In one or more embodiments, the electronic apparatus 100 may capture the image projected by the projector 200 a plurality of times, and obtain the second internal parameter through triangulation by comparing a plurality of captured images. Examples of above are described in greater detail below with reference to the drawings.

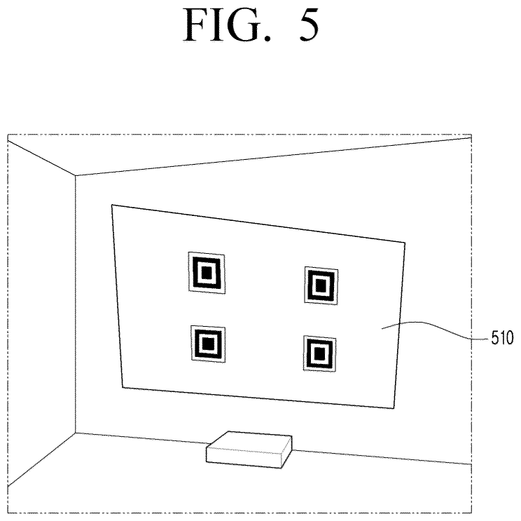

The projector 200 may project a pattern image at operation S430. For example, the pattern image may be an image that has a plurality of patterns. In one or more embodiments, the projector 200 may project a pattern image 510 including a plurality of pattern objects having a geometrical shape as shown in FIG. 5. For example, the plurality of pattern objects may be spaced apart from a center of the pattern image by a predetermined distance. However, embodiments are not limited thereto, and may be implemented as pattern images of various forms such as a checkerboard image.

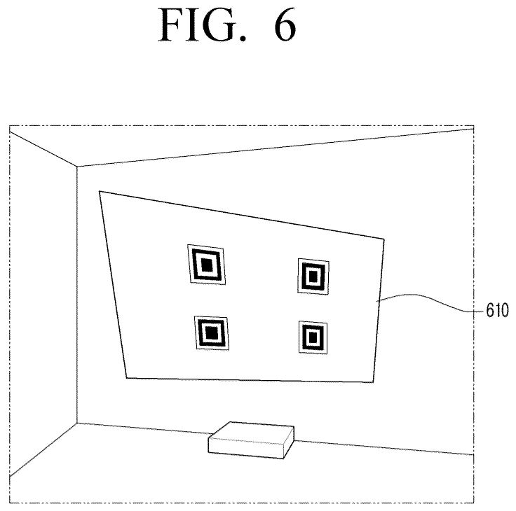

The electronic apparatus 100 may capture the pattern image projected onto the projection surface at operation S440 to obtain a captured pattern image. For example, the electronic apparatus 100 may capture the pattern image from a random or arbitrary point rather than the front side of the projection surface. Accordingly, the captured pattern image may be a quadrangular shape 610 having a distorted form as shown in FIG. 6 rather than the rectangular shape.

The electronic apparatus 100 may obtain the pose information of the electronic apparatus 100 and the projection surface information at operation S450. For example, the pose information of the electronic apparatus 100 may include information about position (e.g., position information) and information about pose (or direction) (e.g., pose information) of the electronic apparatus 100 within the 3-dimensional space. For example, the position information may indicate a position on an x-axis, a y-axis, and a z-axis at which the electronic apparatus 100 is positioned within the 3-dimensional space, and the pose information may indicate information about a pitch angle rotated based on the x-axis, information about a yaw rotated based on the y-axis, and information about a roll angle rotated based on the z-axis.

According to embodiments, the electronic apparatus 100 may obtain the pose information of the electronic apparatus 100 and the projection surface information based on the first and second internal parameters and the captured pattern image. For example, the electronic apparatus 100 may identify or determine, using the fundamental matrix, the center pixel positioned between the pattern pixels corresponding to the plurality of patterns and the plurality of patterns included in the pattern image projected by the projector 200, and the pixel matching information between the pattern pixels and the center pixel captured by the camera of the electronic apparatus 100. For example, the fundamental matrix may be a 3×3 matrix based on the internal parameter and an external parameter of two cameras, and may identify or determine information about a relative position and direction (e.g., rotation and movement) of the camera. The internal parameter and the external parameter extracted from the fundamental matrix may be represented according to Equation 1 below.

$$s [ \begin{matrix}x \\ y \\ 1\end{matrix} ] = [ \begin{matrix}{f}_{x} & {skew\_cf}_{x} & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] = A [ R \vert t ] [ \begin{matrix}X \\ Y \\ Z \\ 1\end{matrix} ] \qquad [ Equation 1 ]$$

In Equation 1,

$$[ \begin{matrix}x \\ y \\ 1\end{matrix} ]$$

may denote 2-dimensoinal pixel coordinates of the camera included in the electronic apparatus 100,

$$[ \begin{matrix}{f}_{x} & {skew\_cf}_{x} & {c}_{x} \\ 0 & {f}_{y} & {c}_{y} \\ 0 & 0 & 1\end{matrix} ]$$

may denote the internal parameter,

$$[ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

may denote the external parameter, and

$$[ \begin{matrix}X \\ Y \\ Z \\ 1\end{matrix} ]$$

may denote 3-dimensional space coordinates. For example, the external parameter may indicate the pose information of the electronic apparatus 100.

In one or more embodiments, the electronic apparatus 100 may identify or determine, using the fundamental matrix, the center pixel positioned between the pattern pixels corresponding to the plurality of patterns and the plurality of patterns included in the pattern image projected by the projector 200, and the pixel matching information between the pattern pixels and the center pixel captured by the camera of the electronic apparatus 100. For example, the pixel matching information may include information about coordinates at which pixels of the pattern image projected by the projector 200 match with pixels captured by the camera of the electronic apparatus 100.

For example, because the electronic apparatus 100 may not know the pose information of the electronic apparatus 100, the pixel matching information between the pixels projected by the projector 200 and the pixels captured by the electronic apparatus 100 may be obtained according to the various pose information of the electronic apparatus 100. In addition, the electronic apparatus 100 may identify or determine the pixel matching information about pixels with respect to the pattern pixels corresponding to the plurality of patterns from among the pixels and the center pixel positioned between the plurality of patterns. Then, the electronic apparatus 100 may identify or determine the pose information of the electronic apparatus 100 such that the pattern pixels are positioned on one plane based on the pixel matching information. In some embodiments, the electronic apparatus 100 may identify or determine the pixel matching information about the pattern pixels, and also the pose information of the electronic apparatus 100 such that the pattern pixels and the center pixel are positioned on one plane, by further using the pixel matching information of the center pixel.

In one or more embodiments, the electronic apparatus 100 may identify or determine the pixel matching information using a random or arbitrary first pose of the electronic apparatus 100. Then, the electronic apparatus 100 may or determine identify the pose information of the electronic apparatus 100 such that the pattern pixels are positioned on one plane by adjusting the pose of the electronic apparatus 100 to a position at which pattern pixels corresponding to at least three patterns are matched to be positioned on a plane.

In one or more embodiments, the electronic apparatus 100 may identify or determine the pixel matching information by using the random or arbitrary first pose of the electronic apparatus 100. Then, the electronic apparatus 100 may identify or determine the pose information of the electronic apparatus 100 such that pattern pixels 720-1 and 720-2 and a center pixel 720-3 are positioned on one plane by adjusting a pose of the electronic apparatus 100 to a position at which the center pixel positioned between the pattern pixels corresponding to the plurality of patterns and the plurality of patterns is matched to be positioned on the plane.

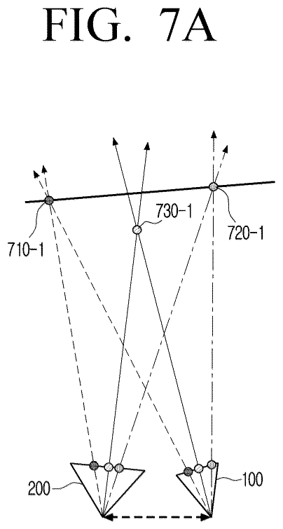

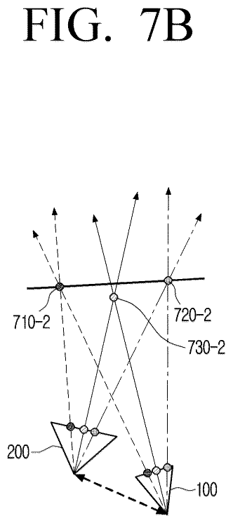

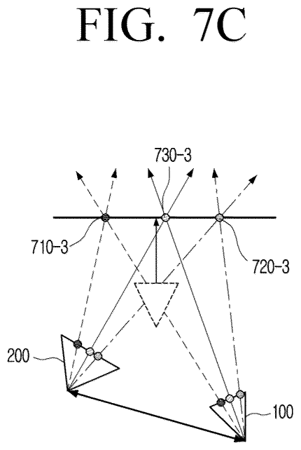

For example, the electronic apparatus 100 may identify or determine pixel matching information of the pattern pixels and the center pixel based on pose information of a plurality of electronic apparatuses 100 as in FIG. 7A to FIG. 7C. For example, as shown in FIG. 7A, if the pose of the electronic apparatus 100 is in the first pose, the electronic apparatus 100 may identify or determine pixel matching information of pattern pixels 710-1 and 720-1 corresponding to a plurality of patterns and a center pixel 730-1 positioned between the plurality of patterns. For example, because the center pixel 730-1 is positioned in front of the pattern pixels 710-1 and 720-1, the electronic apparatus 100 may identify or determine that the pattern pixels 710-1 and 720-1 and the center pixel 730-1 are not positioned on one plane. Then, the electronic apparatus 100 may correct the pose of the electronic apparatus 100 to a second pose as shown in FIG. 7B. Then, the electronic apparatus 100 may identify or determine pixel matching information of pattern pixels 710-2 and 720-2 corresponding to a plurality of patterns and a center pixel 730-2 positioned between the plurality of patterns. Likewise, because the center pixel 730-2 is positioned in front of the pattern pixels 710-2 and 720-2, the electronic apparatus 100 may determine that the pattern pixels 710-2 and 720-2 and the center pixel 730-2 are not positioned on one plane. Then, the electronic apparatus 100 may correct the pose of the electronic apparatus 100 to the second pose as shown in FIG. 7C. Then, the electronic apparatus 100 may identify or determine pixel matching information of pattern pixels 710-3 and 720-3 corresponding to a plurality of patterns and a center pixel 730-3 positioned between the plurality of patterns. For example, the electronic apparatus 100 may identify or determine that the pattern pixels 710-3 and 720-3 and the center pixel 730-3 are positioned on one plane.

Accordingly, the electronic apparatus 100 may identify or determine information about a third pose as pose information of the electronic apparatus 100 in which the pattern pixels 710-3 and 720-3 and the center pixel 730-3 are positioned on one plane. Then, the electronic apparatus 100 may identify or determine, when the electronic apparatus 100 is in the third pose, projection surface information based on information about one plane on which the pattern pixels 710-3 and 720-3 and the center pixel 730-3 are positioned. For example, the projection surface information may include an angle to which the projection surface is tilted in the 3-dimensional space, a size of the projection surface, and information about positions and the like for the pattern and center point within the projection surface.

For example, the electronic apparatus 100 may identify or determine the pose information of the electronic apparatus 100 and the projection surface information about a projection surface on which a plurality of pattern pixels (or pattern pixels and the center pixel) is positioned on one plane based on the pixel matching information, and through the above, identify or determine the pose information of the electronic apparatus 100 and the projector 200 and the projection surface information about the 3-dimensional space in which the electronic apparatus 100 and the projector 200 are positioned.

The electronic apparatus 100 may obtain virtual viewpoint information about the virtual viewpoint at operation S460. For example, the electronic apparatus 100 may identify or determine the viewpoint spaced apart by a predetermined distance in the forward direction from the projection surface on which the pattern pixels are positioned on one plane as a virtual viewpoint. For example, the virtual viewpoint may be a virtual point at which a user is predicted to be positioned in the forward direction from the projection surface, and may be a viewpoint spaced apart by the predetermined distance from the center pixel. According to embodiments, the virtual viewpoint may be referred to as, for example, and without limitation, a target viewpoint, a virtual camera viewpoint, a viewing point, and the like.

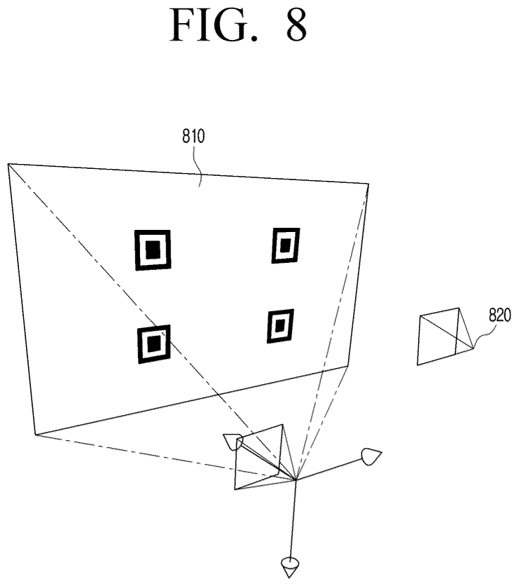

For example, as described above, the electronic apparatus 100 may identify or determine the projection surface information using operation S450. Then, the electronic apparatus 100 may identify or determine a viewpoint spaced apart from the center pixel of the projection surface by a predetermined distance as the virtual viewpoint. For example, as shown in FIG. 8, if a projection surface 810 is identified or determined, the electronic apparatus 100 may identify or determine a virtual viewpoint 820 at a point spaced apart by a predetermined distance from a center pixel of the projection surface 810 toward the forward direction.

However, the virtual viewpoint being positioned at a point spaced apart by a predetermined distance from the center pixel of the projection surface 810 toward the forward direction is merely an example, and the virtual viewpoint may be positioned at a point spaced apart by a predetermined distance from another point of the projection surface 810 toward the forward direction.

The electronic apparatus 100 may obtain the keystone correction information at operation S470. For example, the electronic apparatus 100 may identify or determine the projection area information of the pattern image projected by the projector visible from the virtual viewpoint based on the pose information of the electronic apparatus 100 and the projection surface information, identify or determine the target projection area of the rectangular shape within the projection area, and obtain the keystone correction information based on the projection area information and the target projection area.

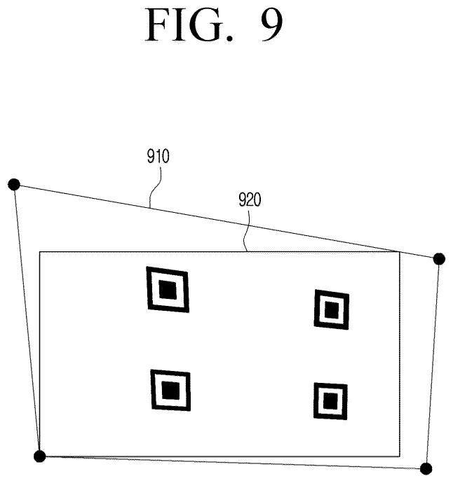

That is, the electronic apparatus 100 may identify or determine position information in the 3-dimensional space at which the virtual viewpoint is positioned through the pose information of the electronic apparatus 100 and the projection surface information, and identify or determine projection area information of the pattern image projected by the projector visible from the virtual viewpoint. For example, the electronic apparatus 100 may identify or determine, as shown in FIG. 9, a quadrangular projection area 910 in a distorted form visible from front side from the virtual viewpoint. Then, the electronic apparatus 100 may identify or determine the target projection area having a rectangular shape within the projection area. For example, the electronic apparatus 100 may identify or determine a target projection area 920 positioned within a vertex of the projection area 910 as shown in FIG. 9.

According to embodiments, the target projection area 920 may be a projection area on which an image projected in the rectangular form through keystone correction can be viewed by the user from the forward direction of the projection area. For example, the target projection area 920 may be the largest rectangular form within the projection area 910. However, the above is merely an example, and the electronic apparatus 100 may set target projection areas of various forms by setting the size of the target projection area, the projection ratio, and the projection direction according to the user input through the UI (e.g., a UI provided by the display 140).

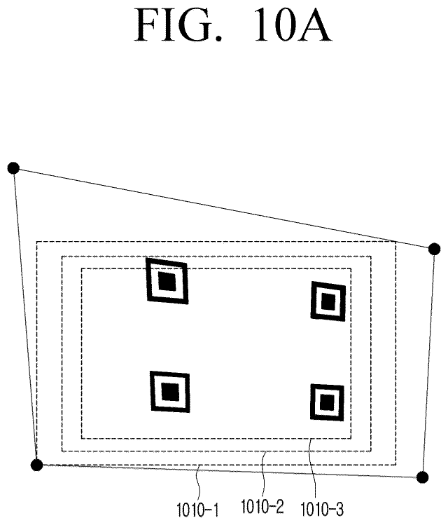

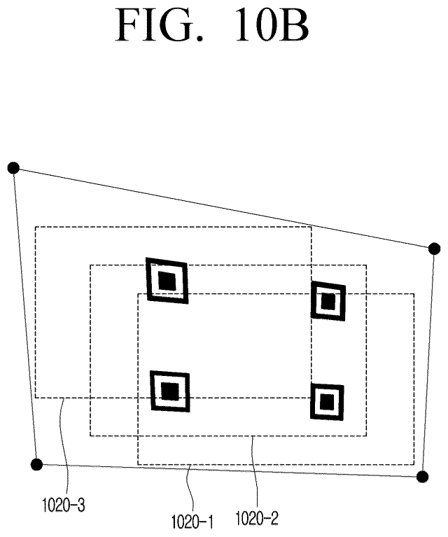

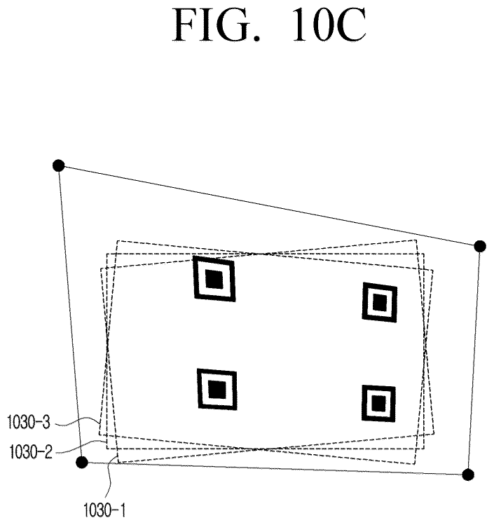

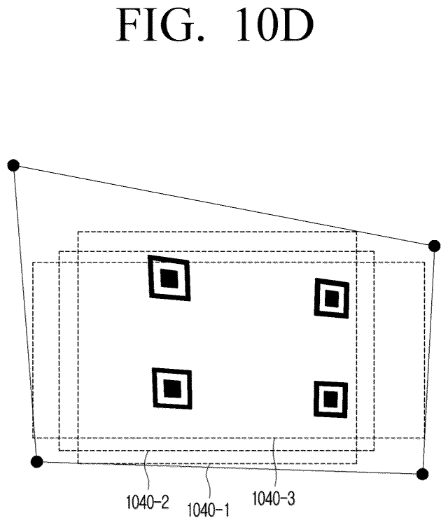

For example, as shown in FIG. 10A, the electronic apparatus 100 may set target projection areas having various sizes (e.g., target projection area 1010-1, target projection area 1010-2, and target projection area 1010-3) according to the user input received using the UI. In another example, as shown in FIG. 10B, the electronic apparatus 100 may set target projection areas 1020-1, 1020-2, and 1020-3 to be projected at various positions according to the user input received using the UI. In another example, as shown in FIG. 10C, the electronic apparatus 100 may set target projection areas 1030-1, 1030-2, and 1030-3 rotated in various directions according to the user input that is through the UI. In another example, as shown in FIG. 10D, the electronic apparatus 100 may set target projection areas 1040-1, 1040-2, and 1040-3 of various ratios according to the user input that is through the UI.

The electronic apparatus 100 may obtain a transformation matrix for transforming pixels of the projection area 910 to pixels of the target projection area 920 based on information about the projection area 910 (e.g., the projection area information) and the target projection area 920. For example, the transformation matrix may be represented according to in Equation 2 below.

$$H = [ \begin{matrix}{h}_{1} {h}_{2} {h}_{3} \\ {h}_{4} {h}_{5} {h}_{6} \\ {h}_{7} {h}_{8} 1\end{matrix} ] \qquad [ Equation 2 ]$$

The transformation matrix may be defined as homography of the 3×3 matrix, and may be a matrix capable of defining a transformation relationship of all points through a 4-point transformation relationship.

Through the method as described above, the electronic apparatus 100 may obtain the keystone correction information that includes the transformation matrix.

The electronic apparatus 100 may transmit the keystone correction information to the projector 200 at operation S480. In one or more embodiments, the electronic apparatus 100 may transmit the keystone correction information that includes the transformation matrix to the projector 200. However, the above is merely one embodiment, and if the electronic apparatus 100 provides an image to the projector, the electronic apparatus 100 may transmit a keystone correction performed image based on the keystone correction information.

The projector 200 may perform keystone correction based on the received keystone correction information at operation S490. For example, the projector 200 may perform keystone correction on an image to be projected by using the transformation matrix included in the keystone correction, and project the keystone correction performed image onto the projection surface.

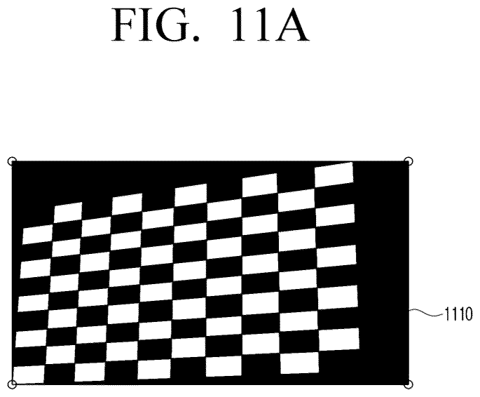

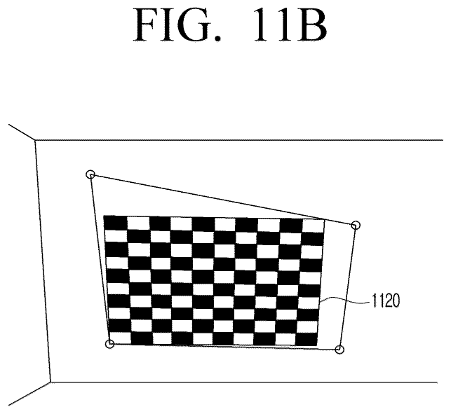

In an embodiment, the projector 200 may project a keystone corrected image 1110 as shown in FIG. 11A. For example, if the user is at the virtual viewpoint positioned at the front side of the projection surface, the user may be able to view an image 1120 having a rectangular shape as shown in FIG. 11B. Accordingly, the user may be provided with an image having a shape that is not distorted through keystone correction, even if the projector 200 is not positioned at the front side of the projection surface.

According to embodiments, the electronic apparatus 100 may pre-store the second internal parameter of the electronic apparatus 100, but embodiments are not limited thereto, and may obtain information about the second internal parameter using the pattern image. For example, in the example described above, the electronic apparatus 100 may have captured the pattern image one time, but embodiments are not limited thereto. For example, the in some embodiments, the electronic apparatus 100 may obtain information about the second internal parameter of the electronic apparatus 100 by capturing the pattern image projected by the projector 200 from a plurality of camera positions.

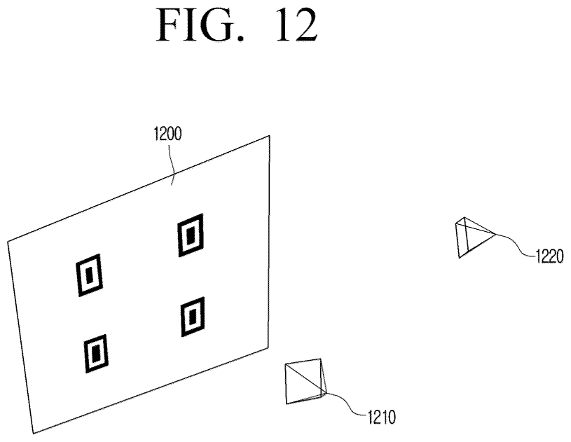

For example, the electronic apparatus 100 may obtain, as shown in FIG. 12, a first image by capturing a pattern image 1200 from a first camera position 1210, and a second image by capturing the pattern image 1200 from a second camera position 1220. Then, the electronic apparatus 100 may obtain the second internal parameter using triangulation by comparing a position of a specific point (e.g., pattern pixels) within the first and second images and the camera positions 1210 and 1220.

For example, the electronic apparatus 100 may perform modeling of a position of a pattern according to Equation 3 below.

$${p}_{proj} ≅ {K}_{proj} \cdot P \qquad [ Equation 3 ]$$

$${{p}^{'}}_{n} ≅ {K}_{cam} \cdot {T}_{n} ( P )$$

In Equation 3, N may denote a number of captures of the images, pₚᵣₒⱼ is a position of the pattern, Kₚᵣₒⱼ may denote the first internal parameter of the projector 200, pₙ may denote a position of a decoded pattern of an N-th camera (e.g., position of a pattern when a plurality of pixels is positioned on one plane), K_{cam} may denote the second internal parameter of the camera 150 of the electronic apparatus 100, \acute{p}ₙ may denote a position of a pattern obtained based on the N-th camera, Tₙ may denote a position of the N-th camera based on the projector 200, and P may denote a 3-dimensional position of the pattern.

Accordingly, the electronic apparatus 100 may identify or determine the second internal parameter which minimizes an error determined according to Equation 4 below.

$${Argmin}_{{T}_{n} , P} ( {\sum }_{N} {\vert {p}_{n} - {{p}^{'}}_{n} \vert}^{2} ) \qquad [ Equation 4 ]$$

For example, when only one captured image is obtained, point information and pose information of one camera have to be obtained, but when a plurality of captured images are obtained, because only the position information of the camera has to be obtained additionally, information about the internal parameter which can be calculated may increase.

Although the electronic apparatus 100 and the projector 200 are described as operating in association therewith to obtain keystone correction information, embodiments are not limited thereto. For example, if the electronic apparatus 100 is implemented as a projector, the keystone correction information may be obtained from inside the electronic apparatus 100.

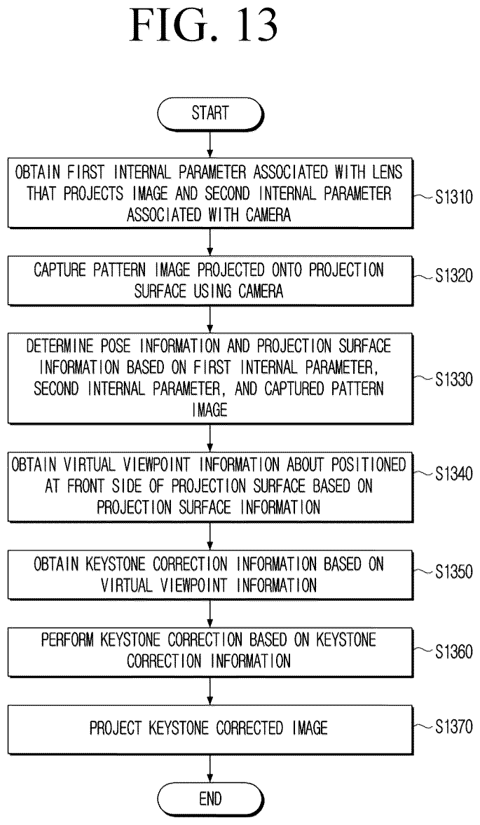

FIG. 13 is a flowchart illustrating an example in which an electronic apparatus projects an image by performing keystone projection according to an embodiment of the disclosure.

First, the electronic apparatus 100 may obtain the first internal parameter associated with the lens that projects an image and the second internal parameter associated with the camera at operation S1310. For example, each of the first and second internal parameters may be the internal parameters for the lens and the camera of the projector provided inside of the electronic apparatus 100, and may be pre-stored, but embodiments are not limited thereto, and may be information received from the external server, and may be obtained using triangulation as described in FIG. 12.

The electronic apparatus 100 may capture the pattern image projected onto the projection surface using the camera at operation S1320.

The electronic apparatus 100 may identify or determine the pose information of the electronic apparatus 100 and the projection surface information based on the first internal parameter, the second internal parameter, and the captured pattern image at operation S1330. For example, the electronic apparatus 100 may identify or determine, using the fundamental matrix, the pixel matching information between the pattern pixels corresponding to the plurality of patterns included in the pattern image projected by the electronic apparatus 100 and the pattern pixels captured by the camera of the electronic apparatus 100. Then, the electronic apparatus 100 may identify or determine the pose information of the electronic apparatus 100 such that the pattern pixels are positioned on one plane based on the pixel matching information.

The electronic apparatus 100 may obtain the virtual viewpoint information about the virtual viewpoint positioned at the front side of the projection surface based on the projection surface information at operation S1340. For example, the electronic apparatus 100 may identify or determine the viewpoint spaced apart by the predetermined distance from the projection surface on which the pattern pixels are positioned on one plane toward the front direction as the virtual viewpoint.

The electronic apparatus 100 may obtain the keystone correction information based on the virtual viewpoint information at operation S1350. For example, the electronic apparatus 100 may identify or determine the projection area information of the pattern image projected by the projector visible from the virtual viewpoint based on the pose information of the electronic apparatus 100 and the projection surface information, identify or determine the target projection area of the rectangular shape within the projection area, and obtain the keystone correction information based on the projection area information and the target projection area.

The electronic apparatus 100 may perform keystone correction on an image to be projected based on the keystone correction information to obtain a keystone corrected image (which may be referred to as a corrected image) at operation S1360.

The electronic apparatus 100 may project the keystone corrected image to the projection surface at operation S1370.

In addition, in the example above, the projector 200 is described as performing keystone correction after the electronic apparatus 100 obtains the keystone correction information and transmits the keystone correction information to the projector 200, but embodiments are not limited thereto, and the keystone corrected image may be transmitted to the projector 200 after the electronic apparatus 100 obtains the keystone correction information and performs keystone correction on the image based on the obtained keystone correction information.

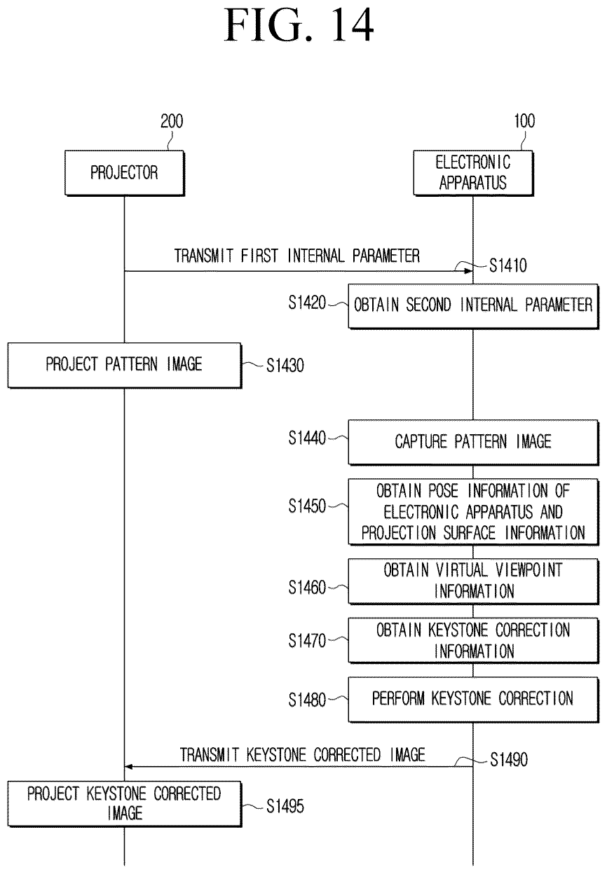

FIG. 14 is a sequence diagram illustrating an example in which an electronic apparatus transmit a keystone corrected image to a projector by performing keystone correction according to an embodiment of the disclosure.

According to embodiments, operations S1410 through S1470 shown in FIG. 14 may be the same as or similar to, or otherwise correspond to, operations S410 through S470 described in FIG. 4. For example, operation S1410 may correspond to operation S410, operation S1420 may correspond to operation S420, operation S1430 may correspond to operation S430, operation S1440 may correspond to operation S440, operation S1450 may correspond to operation S450, operation S1460 may correspond to operation S460, and operation S1470 may correspond to operation S470. Therefore, redundant descriptions or duplicative descriptions of these operations may be omitted.

The electronic apparatus 100 may perform keystone correction based on the keystone correction information at operation S1480. For example, the electronic apparatus 100 may not transmit the keystone correction information directly to the projector 200, and may instead first perform keystone correction on an image to be projected by the projector 200 to obtain a keystone corrected image (e.g., a corrected image).

Then, the electronic apparatus 100 may transmit the keystone corrected to the projector 200 at operation S1490.

The projector 200 may project the keystone corrected image at operation S1495. Based on the above, the projector 200 may project the keystone corrected image even without high computing resources.

Meanwhile, a method according to the various embodiments of the disclosure may be provided included a computer program product. The computer program product may be exchanged between a seller and a purchaser as a commodity. The computer program product may be distributed in a form of a machine-readable storage medium (e.g., a compact disc read only memory (CD-ROM)), or distributed (e.g., downloaded or uploaded) online through an application store (e.g., PLAYSTORE™) or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

A method according to the various embodiments of the disclosure may be implemented with software including instructions stored in a machine-readable storage media (e.g., computer). The machine may call an instruction stored in the storage medium, and as a device operable according to the called instruction, may include an electronic apparatus (e.g., a TV) according to the above-mentioned embodiments.

According to embodiments, the machine-readable storage medium may be provided in a form of a non-transitory storage medium. Herein, “non-transitory” merely means that the storage medium is a tangible device, and does not include a signal (e.g., electromagnetic waves), and the term does not differentiate data being semi-permanently stored or being temporarily stored in the storage medium. In an example, the “non-transitory storage medium” may include a buffer in which data is temporarily stored.

Based on the instruction being executed by the processor, the processor may directly or using other elements under the control of the processor perform a function corresponding to the instruction. The instruction may include a code generated by a compiler or executed by an interpreter.

While some embodiments of the disclosure are illustrated and described above, it will be understood that the embodiments are intended to be illustrative, and not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a camera;
at least one processor; and
a memory storing instructions which, when executed individually or collectively by the at least one processor, cause the electronic apparatus to:
obtain a first internal parameter associated with a lens of a projector configured to project an image, and a second internal parameter associated with the camera,
capture, using the camera, a pattern image projected onto a projection surface by the projector,
determine pose information about a pose of the electronic apparatus and projection surface information about the projection surface based on the first internal parameter, the second internal parameter, and the captured pattern image,
obtain virtual viewpoint information about a virtual viewpoint positioned at a front side of the projection surface based on the projection surface information, and
generate keystone correction information based on the virtual viewpoint information,
wherein the keystone correction information is used to perform keystone correction on at least one image projected onto the projection surface by the projector.

2. The electronic apparatus of claim 1, wherein the instructions, when executed individually or collectively by the at least one processor, cause the electronic apparatus to:
determine, using a fundamental matrix, a center pixel positioned between a plurality of patterns included in the pattern image and pattern pixels corresponding to the plurality of patterns, and
determine, using the fundamental matrix, pixel matching information between the pattern pixels and the center pixel.

3. The electronic apparatus of claim 2, wherein the pose information and the projection surface information are determined such that the pattern pixels are positioned on one plane based on the pixel matching information.

4. The electronic apparatus of claim 3, wherein the virtual viewpoint is spaced apart from the projection surface by a predetermined distance in a forward direction with respect to the projection surface.

5. The electronic apparatus of claim 4, wherein the virtual viewpoint is spaced apart from the center pixel by the predetermined distance.

6. The electronic apparatus of claim 4, wherein the instructions, when executed individually or collectively by the at least one processor, cause the electronic apparatus to:
determine projection area information about a projection area of the pattern image that is visible from the virtual viewpoint based on the pose information and the projection surface information,
determine a target projection area having a rectangular shape within the projection area, and
determine the keystone correction information based the projection area information and the target projection area.

7. The electronic apparatus of claim 6, wherein a size, a projection ratio, and a projection direction of the target projection area are set according to a user input received using a user interface (UI).

8. The electronic apparatus of claim 1, wherein the instructions, when executed individually or collectively by the at least one processor, cause the electronic apparatus to:
capture the pattern image from a plurality of camera positions using the camera to obtain a plurality of captured pattern images, and
obtain the second internal parameter using triangulation by comparing a plurality of positions of a specific point within the plurality of captured pattern images and the plurality of camera positions of the camera.

9. The electronic apparatus of claim 1, wherein the first internal parameter comprises information about a focal length of the lens and a principal point of the lens, and
wherein the second internal parameter comprises information about a focal length of the camera and a principal point of the camera.

10. A controlling method of an electronic apparatus, the method comprising:
obtaining a first internal parameter associated with a lens of a projector configured to project an image, and a second internal parameter associated with a camera of the electronic apparatus;
capturing, using the camera, a pattern image projected onto a projection surface by the projector;
determining pose information about a pose of the electronic apparatus and projection surface information about the projection surface based on the first internal parameter, the second internal parameter, and the captured pattern image;
obtaining virtual viewpoint information about a virtual viewpoint positioned at a front side of the projection surface based on the projection surface information; and
generating keystone correction information based on the virtual viewpoint information,
wherein the keystone correction information is used to perform keystone correction on at least one image projected onto the projection surface by the projector.

11. The method of claim 10, wherein the determining of the pose information and the projection surface information comprises:
determining, using a fundamental matrix, a center pixel positioned between a plurality of patterns included in the pattern image and pattern pixels corresponding to the plurality of patterns, and
determining, using the fundamental matrix, pixel matching information between the pattern pixels and the center pixel captured by the camera.

12. The method of claim 11, wherein the pose information and the projection surface information are determined such that the pattern pixels are positioned on one plane based on the pixel matching information.

13. The method of claim 12, wherein the virtual viewpoint is spaced apart from the projection surface by a predetermined distance in a forward direction with respect to the projection surface.

14. The method of claim 13, wherein the virtual viewpoint is spaced apart from the center pixel by the predetermined distance.

15. The method of claim 13, wherein the generating of the keystone correction information comprises:
determining projection area information about a projection area of the pattern image that is visible from the virtual viewpoint based on the pose information and the projection surface information;
determining a target projection area having a rectangular shape within the projection area; and
determining the keystone correction information based on the projection area information and the target projection area.
